(19) United States
(12) Patent Application Publication
(10) Pub. No.: US 2007/0288395 A1
(43) Pub. Date: Dec. 13, 2007

(54) Method and system for network marketing

(75) Inventor: Frank S. Maggio, Pinellas Park, FL (US)

Correspondence Address: KING & SPALDING LLP, 1180 PEACHTREE STREET, ATLANTA, GA, 30309-3521, US

(73) Assignee: MEDIA IP HOLDINGS, LLC

(21) Appl. No.: 11/701,168

(22) Filed: Feb. 1, 2007

Related U.S. Application Data
(60) Provisional application No. 60/764,728, filed on Feb. 2, 2006.

(51) Int. Cl. G06Q 30/00

(52) U.S. Cl. 705/80; 705/14

(57) ABSTRACT

A first entity can recruit a second entity to collaborate in a promotional activity, such as marketing a product or spreading commercial information via a multi-level marketing program. If the first entity achieves success, the second entity can benefit. Thus, in response to the first entity meeting some objective connected with the promotional activity, the second entity can receive financial gain or something else desirable. The success achieved by the first entity can comprise receipt of a prize, meeting a sales goal, exposing a message to a target audience, recruiting participants into the program, etc. The benefit received by the second entity can comprise money, a prize, admission to a contest, a product, redeemable points, credits, a service, or something else of interest or economic value. A third entity that secured the first entity's participation can also receive a benefit in response to the first entity's success.

### CROSS REFERENCE TO RELATED APPLICATIONS

This application claims priority to U.S. Provisional Patent Application No. 60/764,728, filed Feb. 2, 2006 in the name of Frank Maggio, and entitled “Method and System for Network Marketing,” the entire contents of which are hereby incorporated herein by reference.

### TECHNICAL FIELD

The present invention relates to marketing and more specifically to enticing multiple levels of people to market a good or service via a multilevel, viral, or other network marketing program and to expand the number of program participants by offering rewards at two or more of the levels.

### BACKGROUND

Conventional multilevel marketing programs are recognized as effective tools for marketing or selling goods and services. Such programs leverage personal relationships and offer participants a potential for economic benefit. In a typical program, an individual commits to promoting a product to his friends and acquaintances while at the same time enlisting those friends and acquaintances to recruit others to engage in promotional activities. Accordingly, a multilevel organization of marketers, promoters, or salespeople forms under that individual, with the individual occupying a top or first level of the organization. The people directly recruited by the level-1 individual occupy the second level of the organization. Those recruited by the level-2 people form the third level of the organization. In this manner, the organization functions as a marketing network and may have numerous levels or tiers.

Benefit typically transmits up the organization, which may resemble a triangle, a pyramid, or a tree when depicted as an organizational chart. When a level-3 person achieves marketing success, he receives a benefit from the program organizer or administrator. He might receive a commission for selling a product, a bonus for signing someone up for a telephone service, or a reward for recruiting another person into the marketing network, for example. In response to the level-3 person's marketing achievement, the person who recruited him to the program, who occupies a position at level 2, also receives a benefit. Further, the person who signed up the successful level-2 recruiter also receives a benefit. The upward distribution of reward, towards the top of the organization, motivates each program participant to enlist more participants, thereby growing the organization. However, focusing the distribution of reward upwards, as typical in most conventional programs, often fosters an uncooperative environment that lacks teamwork. Rather than encouraging the promotion of products, participants may engage exclusively in recruiting activities. A participant may even feel resentful of his sponsor's success. Moreover, people who can effectively promote products or services may elect not to participate if they are not comfortable in a recruiting role. For many people, the cost of participation may outweigh the chance of reward in a conventional marketing program. Later entrants who have paid fees to participate in the program face a risk of “holding the bag” at the end of a program cycle, when interest in the program declines, recruiting becomes more difficult, and they can not easily collect participation fees from others who have become wary.

To address those representative deficiencies in the art, a need exists for motivating collaboration among participants in a multilevel marketing program. Another need exists for providing benefit or reward to two people on different levels of a multilevel marketing program. Yet another need exists for managing or operating a multilevel marketing program or a contact network in a manner that stimulates rapid or efficient marketing results or the distribution of promotional messages. Still another need exists for rewarding recruiting activities that bring in additional recruiting capabilities and/or marketing talent. A capability fulfilling one or more of those needs would benefit program participants and parties seeking to distribute good, services, messages, or promotional information.

### SUMMARY OF THE INVENTION

The present invention supports operating a marketing, referral, or sales network in a manner that stimulates rapid distribution of goods, services, messages, promotional content, or commercial information. The distribution can comprise waves of people signing up to purchase a service, to participate in an event, or to consume a product, for example.

In one aspect of the present invention, a first person can recruit, enlist, signup, nominate, sponsor, or engage at least one other person, a second person, to help market a product or service or to spread commercial information, such as a promotional message. The first and second persons can be humans, organizations, business entities, teams of people, companies, government institutions, etc. If the first person achieves success, the second person can receive at least some benefit. Thus, in response to the first person meeting some objective in connection with his activities in the marketing program, the second person, can enjoy a financial gain or some other benefit. The success achieved by the first person can be receipt of a prize, winning a game, meeting a sales goal, exposing a message to a target number of people, or signing up a threshold amount of participants, for example. To name a few possibilities, the benefit received by the second person can be money, a prize, entry into a contest, a product, redeemable points, a service, a product, or some other item of human interest or economic value. A third person who recruited the first person into the program may also receive benefit in connection with the first person's success. Thus, as a result of his recruiting role, the third person can be a benefactor of the first person's success.

Other aspects, systems, methods, features, advantages, and objects of the present invention will become apparent to one with skill in the art upon examination of the following drawings and detailed description. It is intended that all such aspects, systems, methods, features, advantages, and objects are included within this description, are within the scope of the present invention, and are protected by any accompanying claims.

### BRIEF DESCRIPTION OF THE DRAWINGS

FIG. 1 is a functional block diagram of an exemplary system for multilevel marketing according to an embodiment of the present invention.

FIG. 2 is an illustration of an exemplary communication that solicits participation in a multilevel marketing program according to an embodiment of the present invention.

FIGS. 3A and 3B, collectively FIG. 3, are a diagram of relationships among participants in an exemplary multilevel marketing program according to an embodiment of the present invention.

FIGS. 4A, 4B, and 4C, collectively FIG. 4, are a flowchart of an exemplary process for managing a multilevel marketing program according to an embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding, but not necessarily identical, parts throughout the different views.

### DETAILED DESCRIPTION OF THE EXEMPLARY EMBODIMENTS

Exemplary embodiments of the present invention can manage or operate a marketing program. Moreover, exemplary embodiments can distribute benefit to a first program participant who achieves a result and to a second participant whom the first participant has recruited, nominated, signed up, sponsored, or registered. Distributing benefit can comprise allocating, apportioning, allotting, rationing, dispensing, administering, dealing, dividing, or otherwise providing benefit. The marketing program can comprise a viral, network, triangle, pyramid, or multilevel organization for selling, promoting, distributing, or advertising a good or a service. The relationships among program participants can form in a tree or branch structure with benefits transmitting both up and down that structure. The achieved result can comprise meeting a sales objective, recruiting a threshold number of people into the program, or accumulating a winning amount of points in a game, for example. The distributed benefit can comprise a commission, a reward, an award, a profit, a prize, entry into a drawing, a product, a coupon, a discount, money, or an item of financial or personal value, either in tangible or intangible form. In one exemplary embodiment, a third participant who brought the first participant into the program can also receive a benefit. Thus, in a multilevel marketing program or scheme, an action on one level can produce benefit on a lower program level and on a higher program level, providing a tri-level benefit distribution.

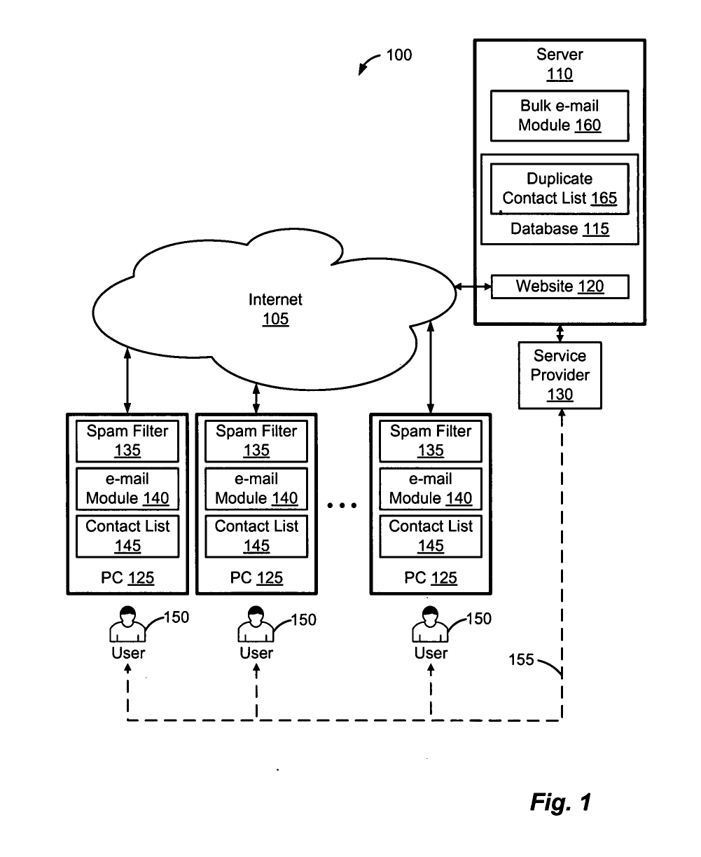

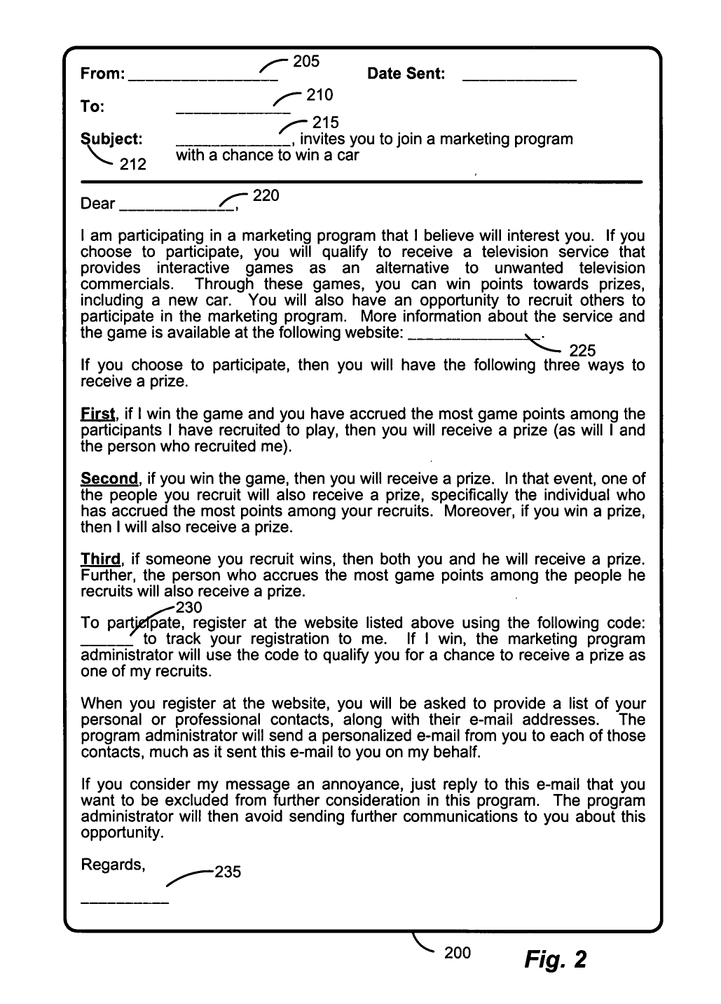

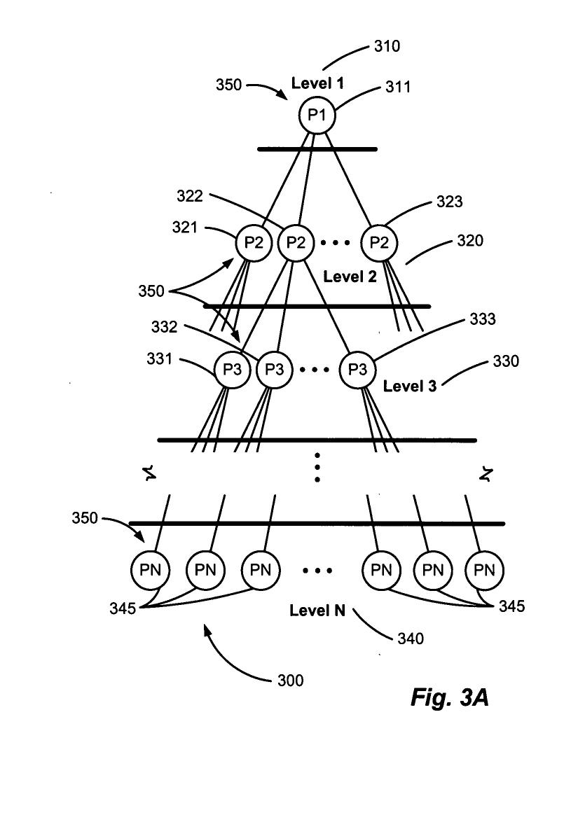

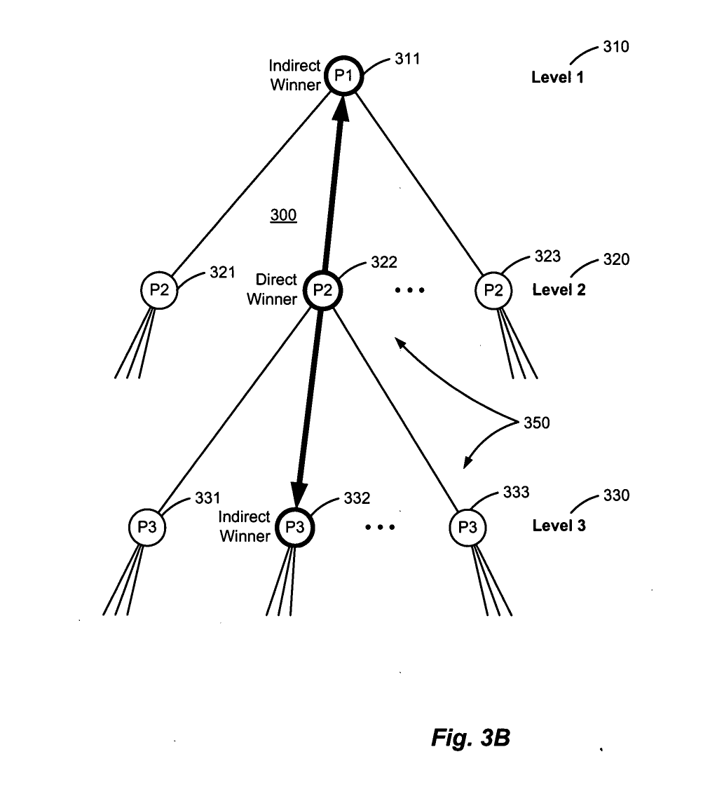

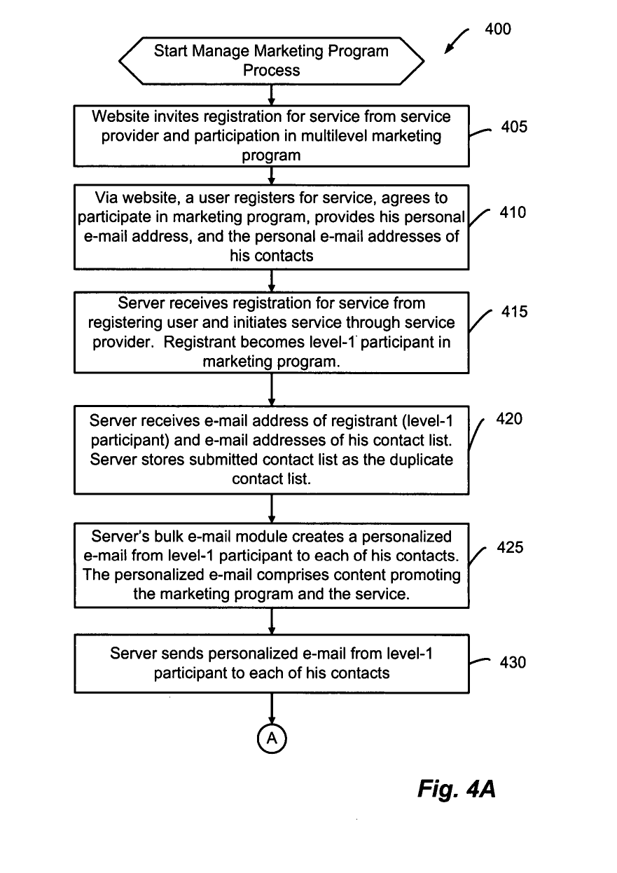

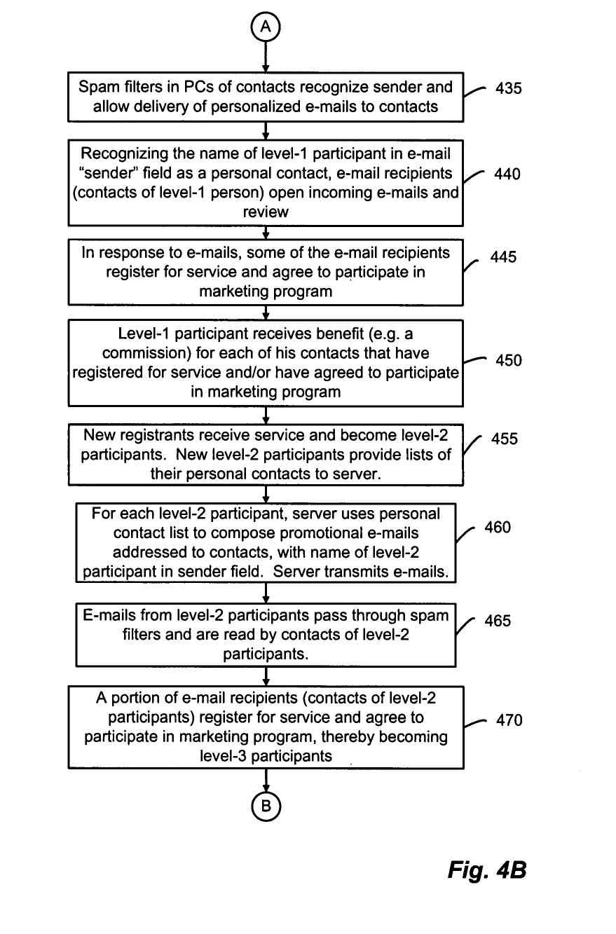

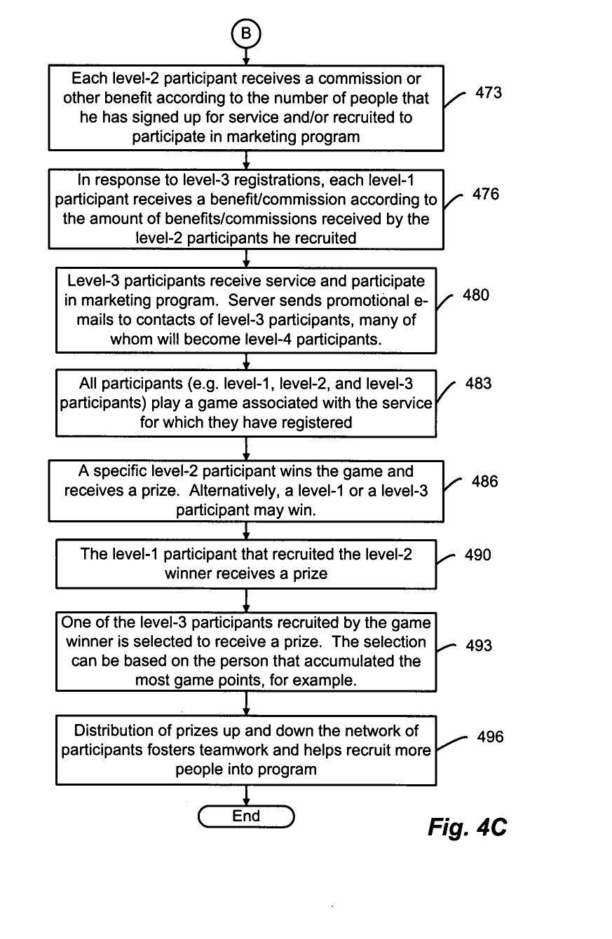

A method and system for managing a marketing program will now be described more fully hereinafter with reference to FIGS. 1-4, which show representative or illustrative embodiments of the present invention. FIG. 1 provides an illustration of a system for managing a marketing program in the context of an exemplary operating environment. FIG. 2 provides an exemplary e-mail for recruiting participants into the marketing program. FIG. 3 shows an organizational diagram of a marketing program and an accompanying benefit distribution scenario. FIG. 4 presents a flow diagram of a method for operating a marketing program and distributing benefits.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting and among others supported by exemplary embodiments of the present invention.

Turning now to FIG. 1, this figure illustrates a functional block diagram of a system 100 for multilevel marketing in accordance with an exemplary embodiment of the present invention. The system 100 can also be viewed as a representative or exemplary environment for operating or practicing an embodiment of the present invention.

The system 100 comprises a communication network, shown as the Internet 105, to support sending information or data among the various other components of the system 100. As an alternative to the Internet 105, the system 100 can comprise another communication system, such as an intranet, a private network, a section of the Internet, a telephony network, an Internet protocol (“IP”) network, a packet-switched network, a circuit-switched network, a local area network (“LAN”), a wide area network (“WAN”), a metropolitan area network (“MAN”), the public switched telephone network (“PSTN”), a wireless network, or a cellular system, for example. The communication network can comprise a link that is optical, fiber optic, wired, wireless, wire-line, waveguided, or satellite-based, to name a few possibilities. Signals transmitting over the communication network can carry or convey data or information digitally or via analog transmission. Such signals can comprise modulated electrical, optical, microwave, radiofrequency, ultrasonic, or electromagnetic energy, among other energy forms.

Users 150 are connected to the Internet 105 via personal computers (“PCs”) 125 or some other computing or communication device comprising a digital controller, a microprocessor, or some other implementation of digital logic. For example, rather than the PC 125, each user 150 can have connectivity to the Internet 105 through a personal computing device, a cell phone, a portable radio, a handheld, a personal data assistant (“PDA”), or a personal messaging device.

In one exemplary embodiment of the present invention, a remote control, capable of tuning a television or another media appliance, provides Internet connectivity. For example, the PC 125 can be replaced by any of the handheld systems, communication devices, or computing devices disclosed in U.S. Patent Application Publication Number 2005/0060232, entitled “Method and System for Interacting with a Writing,” filed in the name of Frank S. Maggio on Oct. 28, 2004, published Mar. 17, 2005, and assigned U.S. patent application Ser. No. 10/976,149.

The PCs 125 execute programmable instructions of software routines or program modules. Among the programs running on each PC 125 is an e-mail module 140 that supports sending and receiving messages over the Internet 105. The e-mail module 140 can comprise the software program sold by Microsoft Corporation under the registered trade name “Microsoft Outlook.” Each of the users 150 can send e-mail messages to various people and hardware elements, including the server 110, the service provider 130, and the other users 150. The Internet 105 facilitates passing communications between or among geographically distant users 150, potentially dispersed across the globe. Thus, one user 150 can send e-mails to and receive e-mails from tens, hundreds, thousands, or millions of other users 150.

In association with its e-mail module 140, each PC 125 has a contact list 145, typically in the form of a data file. The contact list 145 contains names and e-mail addresses of personal acquaintances, friends, family members, relatives, professional contacts, and/or other people whom the PC user 150 knows.

Each PC 125 also has a spam filter 135, typically embodied in a software module executing thereon. The spam filter 135 attempts to block mass-distributed communications from suspect sources, including e-mails addressed to multiple recipients that have been sent from unknown or suspicious senders. The spam filter 135 also can recognize patterns in text, images, or hypertext markup language (“HTML”) of an incoming e-mail that indicate unwanted sales or marketing content. Operating transparently to the PC user 150, the spam filter 135 diverts such e-mails to a “junk” folder or an electronic “trashcan,” thereby shielding him from annoying solicitations.

In one exemplary embodiment, the spam filter 135 is a module associated with and/or maintained by an Internet service provider (“ISP”). The spam filter 135 can alternatively be associated with the PC's operating system or the e-mail module 140. Security or virus protection software operating on the PC 125 may comprise the spam filter 135.

While blocking e-mail communications deemed unworthy of delivery, the spam filter 135 allows delivery of e-mails from sources known to be friendly. The spam filter 135 typically grants delivery permission to e-mails from the people on the contact list 145 of the spam filter's associated PC 125. In other words, the spam filter 135 of a given PC 125 presents to the user 150 of that PC 125 e-mails from senders whom the user 150 knows, as represented in that user's contact list 145.

The service provider 130 can be an entity, such as a for-profit business, an organization, a government, a nonprofit, or some other institution, that seeks to interact with two or more of the users 150. The service provider 130 could even be a person, a political group, a grassroots lobbying group, or a campaign. Further, a manufacturer or distributor that sells physical goods or products may function in the system 100 in the role of the service provider 130.

The dashed line 155 of FIG. 1 represents desired interaction between the service provider 130 and the users 150, or some would-be constituent relationship. In one exemplary embodiment, the service provider 130 wants to quickly secure agreements from a large number of the users 150 for receipt of a media service, such interactive television. In that situation, the dashed line 155 represents potential service agreements. The number of agreements sought by the service provider 130 could be on the order of hundreds, thousands, or millions, or in a range thereof, for example. In one exemplary embodiment, the service provider 130 desires to vend a communication service, such as a cellular telephone service, to a geographically or demographically defined subset of the users 150.

In another exemplary embodiment, the service provider 130 is a multilevel marketing organization. Thus, the service provider 130 can be an organization that distributes products, information, or services on a referral or pass-through basis, with one party passing or referring sales to another party who in turn passes or refers sales to a third party.

The server 110 links the service provider 130 to the Internet 105, which, as discussed above, provides connectivity to each user 150 via his associated computing or communication device. The service provider 130 can directly or indirectly operate, manage, or control the server 110. The service provider 130 can contract an owner of the server 110 to send messages to and receive messages from the users 150. Alternatively, the service provider 130 can maintain the server 110 on its premises. In either case, the server 110 provides a facility through which the service provider 130 efficiently communicates with the users 150. As will be discussed in further detail below, such communications help the service provider 130 achieve its business or operational objectives, typically enhancing its proficiency to promote products and/or services.

The server 110 contains a bulk e-mail module 160 that supports mass, bulk, or volume communication with multiple users 150. The bulk e-mail module 160 comprises software that processes incoming e-mails and sends outgoing e-mails to sets, groups, or lists of the users 150. The bulk e-mail module 160 can transmit, in broadcast fashion, an e-mail to a plurality of users 150. Those targeted users 150 can be selected according to a demographic, psychographic, or geographic profile or criterion, for example.

The selected users 150 can receive a standard e-mail based on common content. Alternatively, the bulk e-mail module 160 can prepare a distinct e-mail for each of the selected users 150. Thus, recipient users 150 can receive e-mails that appear personalized, customized, or tailored, rather than generic or impersonal. Moreover, personalized e-mails typically have a better chance of passing through the spam filters 135 than impersonal e-mails. In other words, the bulk e-mail module 160 can create individualized e-mails that are likely to be delivered rather than intercepted or blocked by the spam filters 135.

The server 110 has an associated database 115 containing e-mail templates and forms that provide the foundation for outgoing e-mails. The bulk e-mail module 160 typically accesses an e-mail template from the database 115 and populates it according to the service provider's objectives.

The bulk e-mail module 160 can place personalized or individualized information into the template. The personalized information can assume a position either in the body of the e-mail or the e-mail's header. For example, an automatically prepared e-mail can reference a personal acquaintance of its intended recipient, thereby increasing that recipient's attentiveness. If included in the header, the reference can be either in the “subject” line or in the “sender” field. Thus, a target user recipient 150, who may have dozens of e-mails in his “in box,” is apt to open and read the e-mail upon viewing personal information in the portion of the e-mail that is visible in the in box. That is, the user's in-box typically displays a list of incoming e-mails along with the sender and the subject line of each listed e-mail. When the user 150 quickly scans the list of incoming e-mails in his in box and sees personalized information associated with an e-mail, he is likely to read, rather than to discard, that e-mail.

In addition to tools and templates for creating e-mails, the database 115 stores one or more lists of users 150 with whom the service provider 130 is interesting in communicating. The stored lists of communication targets are typically in the form of machine readable files or data records. The bulk e-mail module 160 retrieves each list from the database 115 and then sends an e-mail to each listed user 150.

In the exemplary embodiment illustrated in FIG. 1, the database 115 contains duplicate contact lists 165 that duplicate the contact lists 145 on the user PCs 125. That is, each of the duplicate contact lists 165 is a duplicate or mirror image of a respective user's contact list 145. The names and addresses on the duplicate contact list 165 can alternatively be a subset of the full list 145 of contacts that the user 150 maintains in his contact list 145.

As discussed in further detail below, the server 110 uses the duplicate contact list 165 to send an e-mail to each of the people listed on the user's contact list 145. The bulk e-mail module 160 formats, prepares, and sends the e-mail to those contacts so that the e-mail appears to have been sent directly by the specific user 150 who created the contact list 145. The bulk e-mail module 160 can be viewed as sending e-mails to those target contacts on behalf of the creator of the original contact list 145.

The server 110 also has an associated website 120 through which users 150 can submit their contact lists 145. Submitted contact lists effectively become the duplicated contact lists 165. The website 120 can be a web portal or an Internet portal. As an alternative to the website 120, users 150 can submit their contact lists 145 to the server via e-mail, postal service, a dedicated communication link, hand delivery, or some other communication facility.

In this manner, the user 150 provides the server 110 with a set of names and e-mail addresses. The server 110 prepares and sends an e-mail to each named person named of the set. To a target recipient, the sent e-mail appears to come directly from the user 150 who provided the names. The personal relationship between the apparent sender and the target increases the probability that the target's spam filter 135 will characterize the sender as non-threatening and allow delivery of the sent e-mail.

Turning now to FIG. 2, this figure illustrates a communication 200 that solicits participation in a multilevel marketing program in accordance with an exemplary embodiment of the present invention. More specifically, FIG. 2 illustrates an e-mail 200 prepared by the server's bulk e-mail module 160 and transmitted via the Internet 105 to a target user 150. As discussed above, the e-mail 200 is targeted for a user 150 disclosed in the contact list 145 that another user 150 has submitted to the server 110 via the website 120.

The e-mail 200 has a “from” or “sender” field 205 that contains the address of the user 150 who submitted the contact list 145 containing the target recipient's name and e-mail address. As discussed above, the server 110 prepares the e-mail 200 so that the target user 150 (the addressee), and his spam filter 135, recognizes the sender as a personal or professional acquaintance.

In this manner, the system 100 helps ensure that important communications, such as the e-mail 200, are not inadvertently blocked by the spam filter 135. That is, the e-mail 200 is prepared in a manner that avoids errant filtering by the spam filter 135, so the spam filter 135 does not erroneously characterize that e-mail 200 as spam.

The e-mail's “to” field 210 contains the name and e-mail address of the intended recipient (the target user 150), as provided via the submitted contact list 145. Thus, the to field 210 specifies the destination to which the server 110 sends the e-mail 200.

The subject line 212 has a field 215 into which the bulk e-mail module 160 inserts the name of the user 150 who submitted the contact list 145, thereby making that individual the apparent sender. Showing a recognized name in the subject line 212 emphasizes that the target user 150 should open and read the e-mail 200, rather than ignoring it.

In addition to the header, the body of the e-mail 200 also contains personalized information. The salutation has a field 220 for inserting the target user's name. The e-mail's content also includes the address of the website 120 through which the e-mail's intended recipient, the target user 150, can submit his contact list 145. That address can be an Internet address, a uniform resource locator (“URL”), a World Wide Web (“WWW”) address, or some other network address, identifier, or locator.

The body of the e-mail 200 also has a field 230 that provides a code to identify the user 150 who submitted the target user's contact information. If the target user 150 chooses to submit his contact list 145 to the server via the website 120, the submission includes the code from the field 230. The server 110 uses the code as a reference to track each contact list submitter in a chain, triangle, pyramid, network, family, line, or organization of submitters who collectively and individually sell, market, and/or promote. Thus, the server 110 accounts for and tracks the recruiting activities of each participant in the multilevel marketing program.

The closing or signature block of the e-mail 200 has a field 235 into which the bulk e-mail module 160 inserts the name of the user 150 who submitted the contact information of the intended recipient/target user 150.

The body of the e-mail 200 discusses or explains the operation of the marketing program and promotes the service provider 130. Thus, the e-mail 200 presents benefits of participation in the marketing program along with a message that the service provider 130 wants to distribute. In the exemplary e-mail 200, the service provider 130 is promoting registration for a media service that provides interactive advertising games in place of ordinary static advertising. The website 120 can provide a comprehensive set of rules and policies for participating in the marketing program, for accruing benefit, for playing games, and for winning.

The e-mail 200, the body content of which is reproduced immediately below, is an example of a communication that the system 100 can rapidly distribute to a large number of users 150.

The next line starts the text of the body of the e-mail 200:

Dear ______,

I am participating in a marketing program that I believe will interest you. If you choose to participate, you will qualify to receive a television service that provides interactive games as an alternative to unwanted television commercials. Through these games, you can win points towards prizes, including a new car. You will also have an opportunity to recruit others to participate in the marketing program. More information about the service and the game is available at the following website:

If you choose to participate, then you will have the following three ways to receive a prize. First, if I win the game and you have accrued the most game points among the participants I have recruited to play, then you will receive a prize (as will I and the person who recruited me). Second, if you win the game, then you will receive a prize. In that event, one of the people you recruit will also receive a prize, specifically the individual who has accrued the most points among your recruits. Moreover, if you win a prize, then I will also receive a prize. Third, if someone you recruit wins, then both you and he will receive a prize. Further, the person who accrues the most game points among the people he recruits will also receive a prize.

To participate, register at the website listed above using the following code: to track your registration to me. If I win, the marketing program administrator will use the code to qualify you for a chance to receive a prize as one of my recruits.

When you register at the website, you will be asked to provide a list of your personal or professional contacts, along with their e-mail addresses. The program administrator will send a personalized e-mail from you to each of those contacts, much as it sent this e-mail to you on my behalf.

If you consider my message an annoyance, just reply to this e-mail that you want to be excluded from further consideration in this program. The program administrator will then avoid sending further communications to you about this opportunity.

Regards,

______

The previous line concludes the text of the body of the e-mail 200.

The reward and benefit distribution scheme discussed in the e-mail 200 is but one example for motivating user registration and participation in accordance with an exemplary embodiment of the present invention. As discussed in further detail below, an array of options are available to provide a party with benefit in response to an occurrence of an event caused by or attributed to someone else who brought that party into the marketing program.

In response to users 150 registering at the website 120 and submitting contact lists 145 of other users 150 who in turn register and refer still other users 150, a multilevel marketing program forms. Further, an organization or network of program participants assembles.

Turning now to FIG. 3, this figure illustrates a diagram 300 of relationships among participants 350 in a multilevel marketing program in accordance with an exemplary embodiment of the present invention. More specifically, the participants 350 comprise the users 150 who have registered for the marketing program and/or the service that the service provider 130 provides. The participants 350 comprise an arbitrary number of people exemplified by the participants 311, 321, 322, 323, 331, 332, 333, 345 that FIG. 3 illustrates.

The first level 310 of the multilevel marketing organization 300 contains a user 150, depicted as the participant 311, who initially registered for the marketing program and the service provider's service. The participant 311 is a user 150 who has joined the marketing program without being recruited by another user 150. The service provider 130 may have recruited the participant 311 via direct mail, targeted Internet advertising, cold calling, a separate e-mail campaign, or a personal relationship, for example. Whereas the organization 300 of FIG. 3 illustrates a single level-1 participant 311, numerous level-1 participants may exist.

In one exemplary embodiment of the present invention, the participant 311 can be viewed as being analogous to an initiator of a chain letter. Thus, a marketing scheme operated in accordance with one exemplary embodiment of the present invention can share certain characteristics with a chain letter.

The users 150 registered by the level-1 participant 311 are positioned at the second level, level 2 320, of the organization 300. Level 2 320 can be viewed as a second tier of a triangle or pyramid, an arm of an organizational chart, a member of a family, a branch of a tree, a point of a line, or a second link in a chain. Level 2 320 specifically contains the user registrants 150 who entered the tracking code 230 of the level-1 participant 311. As discussed above, the contact list 145 submitted by the level-1 participant 311 contains a line item for each of the level-2 participants 321, 322, 323. That contact list 145 may also contain other users 150 who elected not to register and thus are not present on the organizational diagram 300.

While an arbitrary number of users 150 can participate at level 2 320, in one exemplary embodiment, that number is limited. For example, in one exemplary embodiment, each participant 350 can register no more than a specified number of users 150. Limiting the number of people any one individual is allowed to recruit can bolster the perceived exclusivity of the program. The limit can be set to 10, 20, 100, 200, or some other number that fits the circumstances.

Level 3, in turn, contains the participants 331, 332, 333 recruited by the level-2 participants 321, 322, 323. Each participant 321, 322, 323 at level 2 320 typically recruits multiple users 150 into the marketing program. However for illustrative purposes, FIG. 3 specifically illustrates the participant 331, the participant 332, and the participant 333 as the people successfully recruited by the level-2 participant 322.

The exemplary multilevel marketing organization 300 has an arbitrary number of levels, with the participants 345 positioned at the bottom or the lowest level. The organization 300 can have as few as 2 levels and as many as 3, 5, 10, 20, 50, or 100, or in a range thereof, for example. In one exemplary embodiment of the present invention, the number of levels is not fixed and can expand to many hundreds or many thousands, for example. Moreover, growth of the organization 300 can occur in stages, intermittently, successively, in iterations, virally, or in an unbounded manner, to name a few possibilities.

FIG. 3B illustrates an exemplary scenario in which the level-2 participant 322 wins the game. The participant 322 may have won by accumulating the most points in the interactive media game discussed in the e-mail 200. Alternatively, the participant 322 might be the most successful salesperson of the organization 300. The winning participant 322 could be a randomly chosen participant 350. The participant 322 might have been selected based on merit, seniority, achieved results, commissions, recruiting power, skill, talent, luck, profit generated for the service provider 130, or some other criterion, for example.

In response to the participant 322 winning or otherwise receiving a benefit in connection with his participation in the marketing program, the level-3 participant 332 and the level-1 participant 311 also win or receive a benefit or an award. The level-1 participant 311 becomes a beneficiary as a result of being the user 150 who recruited the winning participant 322 into the marketing program. The level-3 participant 323 becomes a beneficiary as a result of being a user 150 recruited by the winning participant 322. Thus, whereas the participant 322 is a direct winner, the participants 311, 332 can be viewed as indirect winners or indirect benefit recipients.

The benefit distribution scheme that FIG. 3 illustrates can be viewed as providing both upstream and downstream value to the participants 350 of a multilevel marketing program.

In most circumstances, including the representative scenario depicted in FIG. 3, the direct winner 322 will have recruited multiple participants, such as the participants 331, 332, 333. Accordingly, a specific prize recipient will be selected among those recruited participants 331, 332, 333. The selection can be based on a wide range of possible criteria. In one exemplary embodiment, the level-3 winner 332 is selected as the individual who accumulated the most points or credits in the game. A winner from level 3 330 can be randomly selected. The direct winner 332 can have discretion to select the indirect winner 332 from the participants 331, 332, 333 he recruited. More generally, the level-3 winner 332 can be selected based on merit, seniority, achieved results, applied efforts, commissions, recruiting power, skill, talent, luck, profit generated for the service provider 130, or some other criterion, for example.

Although FIG. 3 illustrates the direct winner 322 in level 2 320 of the organization 300, a participant 350 from another level 310, 330, 340 can win. For example, if a participant 350 at level 4 becomes a direct winner, then a participant 350 from level 3 330 and a participant from level 5 (not explicitly illustrated in FIG. 3) will become indirect winners.

In the event that the level-1 participant 311 wins, then he will receive the first of three prizes, and one of his recruits 321, 322, 323 (on level 2 320) will receive the second prize. In one exemplary embodiment of the present invention, a third prize winner is selected at random from the total pool of participants 350 or from the participants 321, 322, 323 recruited by the winning level-1 participant 311. In one exemplary embodiment of the present invention, the level-1 participant 311 receives the third prize in addition to the first prize. In one exemplary embodiment of the present invention, a single selected recruit of the winning level-1 participant 311 receives two prizes. In one exemplary embodiment of the present invention, a level-3 participant recruited by the indirect winner at level 2 320 wins.

Turning now to FIG. 4, this figure illustrates a flowchart of a process 400 for managing a multilevel marketing program in accordance with an exemplary embodiment of the present invention. The Process 400, entitled Manage Marketing Program, will be described with exemplary reference to FIGS. 1, 2, and 3, which are discussed above.

At Step 405, the website 120 invites the users 150 to register for participation in the multilevel marketing program and for the service that the service provider 130 offers. The service provider 130 may use banner advertising to implement Step 405, for example.

At Step 410, one of the users 150 responds to the invitation and registers for the service and for participation in the marketing program. The registering user 150 submits his name, e-mail address, and the contact list 145 to the website 120, typically via entering information into an electronic form accessible at the website 120. The submitted contact list 145 contains names and e-mail address of users 150 with whom the registering user 150 has a personal or professional relationship.

At Step 415, the server 110 receives the registering user's registration and data inputs. The server 110 notifies the service provider 130 of the registration, and the service provider 130 provides the requested service. The registrant becomes the level-1 participant 311 on the marketing organization 300.

While the requested service could be most any product or service, in one exemplary embodiment, the service comprises alternative television advertising. More specifically, the service can present interactive television commercials that offer viewers a chance to accumulate points in response to answering questions about commercial content associated with a pod of commercials.

At Step 420, the server 110 receives the contact list 145 that the registering user, who has now become the level-1 participant 311, has submitted. The server 110 stores that submitted contact list 145 in the database 115 as the duplicate contact list 165.

At Step 425, the bulk e-mail module 160 of the server 110 prepares an individualized e-mail 200 for each user 150 on the duplicate contact list 165. As discussed above with reference to FIG. 2, the personalized e-mail 200 comprises content promoting participation in the marketing program as well as content promoting the interactive television service.

At Step 430, the server 110 sends a personalized version of the e-mail 200 over the Internet 105 to each user 150 represented on the submitted contact list 145 of the level-1 participant 311.

At Step 435, illustrated on FIG. 3B, the sent e-mails 200 arrive at the respective spam filters 135 of the intended recipients. The spam filters 135 recognize the e-mail sender as an individual known to the respective intended recipients. Thus, the spam filters 135 characterize most of the incoming e-mails 200 as low-risk or non-nuisance communications and allow e-mail delivery.

At Step 440, intended recipients check their e-mail “in boxes.” Recognizing the senders of the e-mails 200 as being personally known, the intended recipients accept, open, and read the incoming e-mails.

At Step 445, at least some of the users 150 who have received and read the e-mail 200 elect to participate in the marketing program. Further, those users 150 opt to receive the media service offered by the service provider 130.

At Step 450, the level-1 participant 311 receives credit for recruiting the users 150 who elected to participate. The level-1 participant 311 may receive a commission or some other defined benefit for this recruiting achievement. Alternatively, the benefit may comprise increasing the probability of the level-1 participant 311 winning the game.

At Step 455, the users 150 recruited by the level-1 participant 311 become level-2 participants 321, 322, 323. The level-1 participant 311 can be viewed as sponsoring or referring those level-2 participants 321, 322, 323. The level-2 participants 321, 322, 323 submit their contact lists 145 to the server 110.

At Step 460, the server 110 composes an individualized promotional e-mail 200 addressed to each person on each contact list 145 of each of the newly-recruited level-2 participants 321, 322, 323. In the sender field 205, the bulk-e-mail module 160 inserts the name of the respective level-2 participant 321, 322, 323 who provided the name and address of the addressee (the target recipient). The server 110 sends the e-mails 200 to the addressee users 150 via the Internet 105.

At Step 465, the e-mails 200 from the level-2 participants 321, 322, 323 encounter the spam filters 135 of the addressee users 150, the intended targets. Recognizing the sender name and/or address, the spam filters 135 allow delivery of many, if not all, of the e-mails 200. The addressee users 150 read the delivered e-mails 200.

At Step 470, a subset of the e-mail recipients, who are contacts of the level-2 participants 321, 322, 323, register for the television/media service and for participation in the marketing program. Those registrants become level-3 participants 331, 332, 333.

At Step 473, the level-2 participants 321, 322, 323 each receives a commission, or some other tangible or intangible benefit, based on the number of level-3 participants 331, 332, 333 who have registered for participation under his respective name or identification code 230.

At Step 476, the level-1 participant 311 receives commissions in response to the new, level-3 registrations. If the organization 300 comprises multiple level-1 participants 311, then selected level-1 participants 311 receive those commissions. Specifically, the selected level-1 participants 311 are the ones who recruited the level-2 participants 321, 322, 323 noted on the level-3 registrations. In other words, in an exemplary embodiment, registration commission or credit accrues or vests two levels up the organization 300. In other exemplary embodiments, exactly one level may be eligible for commission, or no financial commissions may be issued.

In one exemplary embodiment of the present invention, names are used to track candidate participants as an alternative to tracking codes submitted at registration. When a user 150 registers for participation and submits his contact list 145, the people on that list 145 become his candidate participants to the extent that another, already-registered participant 350 has not already claimed them. In one embodiment, the period of exclusivity can endure forever, throughout the lifespan of the persons involved, or during a specific marketing cycle or event.

Alternatively, the system 100 can grant submitted names protected status for a fixed period of time, such as five days, two weeks, one or two months, etc. That is, for a defined period of time following the date that he submits his contact list 125, a registrant can receive exclusive credit for any person on that submitted list 125 who agrees to participate. After that defined period of time elapses, exclusivity expires. At that time, another registrant can receive credit for successfully recruiting listed individuals who have not already become participants 350.

At Step 480, the service provider 130 provides the requested service to the level-3 participants 331, 332, 333, and their participations in the marketing program begin. The server 110 prepares and sends individualized e-mails 200 to the contacts of the level-3 participants 331, 323, 333. A portion of those targets become level-4 participants in response to receipt of those e-mails 200. In turn, level-4 participants recruit level-5 participants. Successive recruiting and stacked levels of participation continue, typically to an arbitrary number of levels.

At Step 483, the participants 350 play a game. As discussed above, an exemplary game involves answering questions about advertising content or commercials that air during commercial breaks of television programming. Each participant 350 accrues or amasses points for submitting correct answers to those questions.

In one exemplary embodiment of the present invention, all of the registered participants 350 are eligible to play the game, and game play is optional. In one exemplary embodiment of the present invention, the participants 350 must qualify to play the game. Qualification may comprise watching and responding to a threshold number of interactive commercials provided by the service provider 130.

Game play can begin at a predetermined time, after the organization 300 grows to a threshold number of participants 350 or levels 310, 320, 330, 340, or in response to an occurrence of some other defined event of interest to the service provider 130, for example.

As an alternative to playing a game that entails interaction with media content, the marketing program can involve participation in a game of chance, a lottery, a contest based on the relative level of financial gain that each participant 350 has generated for the service provider 130, or some other activity that brings tangible or intangible benefit to the service provider 130, for example.

At Step 486, a specific one of the participants 350 wins the game. While most any participant 350 might win, for purposes of illustration, the flowchart of Process 400 assumes that the level-2 participant 322 wins. In association with winning, that participant 322 receives a prize, a reward, or some tangible or intangible benefit or gain. In one exemplary embodiment of the present invention, the prize comprises a trophy or professional recognition or confers bragging rights without necessarily providing any item of substantive economic value.

At Step 490, the level-1 participant 311 who recruited or sponsored the level-2 winner 322 receives a reward. That reward can be a second instance of the reward that the level-2 participant 322 received. Alternatively, the level-1 reward can be distinct. The level-1 reward can have less value than the level-2 reward or a value that is scaled up or down based on some criterion.

At Step 493, a selected one of the level-3 participants 331, 332, 333 recruited by the level-2 winner 322 receives a prize. That prize can be essentially the same prize issued at level-1 310. Alternatively, the level-3 prize can be scaled down or scaled up in terms of perceived or actual value. The scheme of providing prizes at three organization levels 310, 320, 330 can be viewed as distributing benefit upstream and downstream in the program.

The prize recipient 333 at level 3 330 can be selected based on one or more criteria of relevance to the marketing program and/or the service provider 130. In one exemplary embodiment of the present invention, the level-3 selection is based on accrual of game points. For example, the recipient 333 can be the individual who correctly answered the highest number of questions associated with the interactive media service. In one exemplary embodiment of the present invention, the recruited level-3 participants 331, 332, 333 play a second game, and the winner of that second game becomes the prize recipient 332.

At Step 496, the distribution of prizes up and down the organization 300 of participants 350 strengthens the multilevel marketing program. More users 150 register, and program membership grows. Collaboration among the participants 350 increases. Not only do strong promoters, marketers, and salespeople join, but also effective recruiters and managers join. The participants 350 are motivated to recruit individuals who may lack sales talent but nonetheless bring recruiting skills or some other useful capability into the organization 300. The service provider 130 realizes progress towards achieving its market or strategic objectives.

Although specific embodiments of the present invention have been described above in detail, the description is merely for purposes of illustration. Various modifications of, and equivalent steps corresponding to, the disclosed aspects of the exemplary embodiments, in addition to those described above, also can be made by those skilled in the art without departing from the spirit and scope of the present invention defined in any claims that follow, the scope of which is to be accorded the broadest interpretation so as to encompass such modifications and equivalent structures.

What is claimed is:

1. A method for conducting a marketing program, comprising the steps of:
selecting a winner in response to holding a contest among participants in the marketing program;
identifying a first one of the participants that the winner recruited into the marketing program;
identifying a second one of the participants that recruited the winner into the marketing program; and
awarding a prize to each of the selected winner, the identified first one of the participants, and the identified second one of the participants.

2. The method according to claim 1, wherein the step of identifying the first one of the participants comprises selecting the first one of the participants from a plurality of participants that the winner recruited into the marketing program.

3. The method according to claim 1, wherein the step of identifying the first one of the participants comprises holding a second contest among participants that the winner recruited into the marketing program.

4. The method according to claim 1, wherein the step of selecting the winner comprises comparing points awarded to each of the participants during the contest.

5. The method according to claim 1, wherein the step of identifying the first one of the participants comprises identifying an individual, among the participants that the winner recruited, who accumulated a highest level of points during the contest.

6. The method according to claim 1, further comprising the step of offering a commission to each of the participants according to achievement in recruiting new participants into the marketing program.

7. The method according to claim 1, further comprising the step of compensating each of the participants based on individual marketing results.

8. The method according to claim 1, wherein the contest comprises a game of chance.

9. The method according to claim 1, wherein the step of selecting the winner comprises assessing performance in the marketing program for each of the participants in the marketing program and identifying a top performer.

10. The method according to claim 1, further comprising the step of recruiting participants into the program via transmitting e-mails to prospective participants.

11. The method according to claim 10, wherein the step of transmitting e-mails comprises directing prospective participants to a website for registration in the marketing program.

12. The method according to claim 10, wherein the step of transmitting e-mails comprises inserting a code into each transmitted e-mail to identify a specific participant from whom the e-mail appears to have been sent.

13. The method according to claim 1, wherein the step of awarding the prize comprises the selected winner, the identified first one of the participants, and the identified second one of the participants receiving different prizes.

14. The method according to claim 1, wherein the step of awarding the prize comprises awarding a first prize to the selected winner, a second prize to the identified first one of the participants, and a third prize to the identified second one of the participants, and
wherein the first, second, and third prizes are essentially identical to one another.

15. A method for holding a marketing campaign that comprises a game, the method comprising the steps of:
enlisting participants in the marketing campaign;
receiving names of prospective participants from each of the enlisted participants; and
for each named prospective participant, transmitting an electronic communication that is addressed to the prospective participant, that identifies a specific one of the enlisted participants who named the prospective participant, and that describes the game,
wherein the game comprises selecting a game winner from among the enlisted participants and awarding a prize to someone the game winner enlisted to participate in the marketing campaign.

16. The method according to claim 15, wherein the game further comprises awarding a second prize to the game winner.

17. The method according to claim 16, wherein the game further comprises awarding a third prize to a party who recruited the game winner to participate in the marketing campaign.

18. The method according to claim 17, wherein the prize, the second prize, and the third prize are essentially identical.

19. The method according to claim 15, wherein the transmitted electronic communication comprises an e-mail individually addressed to the prospective participant.

20. The method according to claim 15, wherein the transmitted electronic communication comprises a link to a website for registering in the marketing campaign and an identification code for entry at the website.

21. The method according to claim 20, wherein the transmitted electronic communication further comprises a header that contains a name of the enlisted participant who named the prospective participant.

22. The method according to claim 15, wherein the electronic communication further comprises an invitation for the prospective participant to submit names of additional prospective participants known personally to the prospective participant.

23. The method according to claim 15, wherein the step of transmitting the electronic communication comprises the steps of:
attaching to the electronic communication a sender address of the enlisted participant who named the prospective participant; and
transmitting the electronic communication from a server to the prospective participant via the Internet.

24. The method according to claim 15, wherein the step of transmitting the electronic communication comprises the steps of:
preparing the electronic communication so that, to a spam filter of the prospective participant, the electronic communication appears to have been transmitted from a computer of the enlisted participant who named the prospective participant; and
transmitting the prepared electronic communication from a different computer.

25. The method according to claim 15, wherein the step of transmitting the electronic communication comprises the steps of:
preparing the electronic communication so that, to a spam filter of the prospective participant, the electronic communication appears to have been transmitted from a network location of the enlisted participant who named the prospective participant; and
transmitting the prepared electronic communication from a different network location.

26. The method according to claim 15, wherein the step of transmitting the electronic communication comprises the steps of:
attaching sender information to the electronic communication so that, to a spam filter of the prospective participant, the electronic communication appears to have been transmitted from a network address associated with the enlisted participant who named the prospective participant; and
transmitting the prepared electronic communication from a server that is remote from the network address.

27. A method for conducting a promotional program, comprising the steps of:
a first entity recruiting a second entity to participate in the promotional program; and
in response to the first entity achieving a threshold level of success in the promotional program, rewarding the first entity and the second entity.

28. The method according to claim 27, further comprising the step of a third entity recruiting the first entity to participate in the promotional program,
wherein the step of rewarding the first entity comprises
in response to the first entity achieving a threshold level of success in the promotional program, rewarding the first entity, the second entity, and the third entity.

29. The method according to claim 27, wherein the step of the first entity recruiting the second entity comprises:
a server accessing an e-mail template;
the server applying a recipient address of the second entity to the e-mail template;
the server applying a sender address of the first entity to the e-mail template; and
the server sending an e-mail correspondence, based on the e-mail template and including the recipient address and the sender address, to the second entity, wherein the server is located at a network site that is remote with respect to the first entity and the second entity.

30. The method according to claim 27, further comprising the step of the first entity and the second entity playing a game of chance associated with the promotional program.

31. A marketing method, comprising the steps of:
holding a marketing program in which:
a first participant recruits a plurality of second participants; and
one of the plurality of second participants recruits a plurality of third participants;
identifying a winner of a contest associated with the marketing program; and
if the one of the plurality of second participants is the winner of the contest, awarding a prize to a selected one of the plurality of third participants.

32. The method according to claim 31, further comprising the step of
awarding a second prize to the first participant if the one of the plurality of second participants is the winner of the contest.

33. The method according to claim 32, further comprising the step of awarding a second prize to the winner.

34. The method according to claim 31, wherein the first participant recruiting the plurality of second participants comprises sending electronic communications to prospective participants from a remote server.

35. A method for conducting a multilevel promotional program in which level-one participants recruit level-two participants and level-two participants recruit level-three participants, the method comprising the steps of:
holding a contest among participants in the multilevel promotional program, the contest having a first award and a second award;
identifying one of the level-two participants as a winner of the contest;
providing the first award to the identified one of the level-two participants; and
providing the second award to a selected one of the level-three participants recruited by the identified one of the level-two participants.

36. The method according to claim 35, further comprises the step of:
providing a third award to a selected one of the level-one participants that recruited the identified one of the level-two participants.

37. The method according to claim 36, wherein the first award, the second award, and the third award are essentially indistinguishable from one another.

38. The method according to claim 35, wherein the step of holding the contest among the participants comprises holding a competition among the level-one participants, the level-two participants, and the level-three to see who can recruit more new participants for the multilevel promotional program.

39. A method for growing participation in a marketing program, comprising the steps of:
enlisting a first plurality of people to participate in the marketing program;
encouraging the first plurality of people to enlist a second plurality of people to participate in the marketing program;
encouraging the second plurality of people to enlist a third plurality of people to participate in the marketing program;
holding a contest among the first plurality of people, the second plurality of people, and the third plurality of people;
identifying a winner of the contest; and
if the winner is among the second plurality of people, selecting a person from the third plurality of people to receive a prize.

40. The method according to claim 39, wherein the selected person from the third plurality of people is selected based on the winner having enlisted the selected person.

41. The method according to claim 39, further comprising the step of presenting the winner with another prize.

42. The method according to claim 39, further comprising the step of selecting a person from the first plurality of people to receive another prize if the winner is among the second plurality of people.

43. The method according to claim 39, wherein an individual from the first plurality of people recruited the winner to participate in the marketing program, and
wherein the step of selecting the person further comprises selecting the individual to receive another prize.

44. The method according to claim 39, wherein the marketing program comprises a sales campaign.
